(19) United States
(12) Patent Application Publication
(10) Pub. No.: US 2012/0243202 A1
(43) Pub. Date: Sep. 27, 2012

(54) VEHICLE LAMP

(75) Inventor: Kenji MATSUOKA, Isehara-shi (JP)

(73) Assignee: ICHIKOH INDUSTRIES, LTD.

(21) Appl. No.: 13/405,879

(22) Filed: Feb. 27, 2012

(30) Foreign Application Priority Data
Mar. 23, 2011 (JP) 2011-063533

(51) Int. Cl. F21V 9/14

(52) U.S. Cl. 362/19

(57) ABSTRACT

A vehicle lamp is provided that includes a base plate 3, a light emitting element 5 mounted with a light output surface faced upward, a polarizing lens 7 formed to have a larger width in an “x” direction than that in a “y” direction. The vehicle lamp that can form a light illumination region that is in a rectangular shape and displaced to one side with respect to an axis vertical to a light output surface of a light emitting element, and also has a clear outline having no blur of the light.

### CROSS REFERENCE TO RELATED APPLICATIONS

This application claims priority of Japanese Patent Application No. 2011-063533 filed on Mar. 23, 2011. The contents of this application are incorporated herein by reference in their entirety.

### BACKGROUND OF THE INVENTION

1. Field of the Invention

The present invention relates to a vehicle lamp, and in particular, to a vehicle lamp including a light emitting element such as a light emitting diode as a light source.

2. Description of the Related Art

In recent years, as a light source of a vehicle lamp, a light emitting element such as a light emitting diode has been increasingly adopted.

In such a case, it may be requested that an illumination region when light from the light emitting diode is emitted on a screen is formed in a landscape shape having a vertically small width.

Therefore, as disclosed in Japanese Patent Application Publication No. 2007-48470 described below, it is known that a so-called polarizing lens is disposed forward in a light illumination direction of the light emitting diode. This polarizing lens has a landscape shape and is an aspheric surface lens including two convex lenses of a substantially same type that are provided in line to have a portion overlapped with each other. The light emitting diode is disposed to oppose the overlapped portion of the polarizing lenses. With this arrangement, light from the light emitting diode is polarized in a lateral direction by the two convex lenses and emitted. Luminance of the light is substantially same as that of the light from the light emitting diode passed through the overlapped portion of respective concave lenses. Therefore, for example, a whole region of the illumination region when the light is emitted on the screen seems luminous with substantially uniform brightness.

However, in the above-described vehicle lamp, the polarizing lens has a bilaterally symmetrical shape with reference to a center thereof, and is disposed corresponding to the center of an axis vertical to the light output surface of the light emitting diode (light emitting element). In other words, FIG. 7A schematically illustrates a relationship of disposing a polarizing lens 20, a light emitting element 21, and a light illumination region 22. As illustrated in FIG. 7A, the light of the light emitting element 21 through the polarizing lens 20 is output symmetrically (γ=α) with respect to an axis “P” vertical to the light output surface of the light emitting element. Therefore, the light has no margin of safety in directivity. And thus, for example, when the light emitting element 21, the polarizing lens 20, and other optical member are disposed in a light room having a comparatively small space, an inconveniency of no freedom is incurred.

FIG. 7B illustrates the light illumination region 22 when the light from the light emitting element 21 through the polarizing lens 20 is emitted on the screen. As illustrated in FIG. 7B, when a light illumination region 23 to be a target is formed in a lateral rectangular shape, the light is not sufficiently emitted at both ends thereof. Further, the light is unnecessarily emitted at an outside of the light illumination region at a center portion thereof. Therefore, for example, when the other optical member such as a prism having the same shape as the light illumination region 23 to be a target is disposed, the light gets out of the optical member, thereby being unable to usefully use the light without spoiling it.

The purpose of the present invention is to provide a vehicle lamp that is invented in consideration of the problems described above, and can form the light illumination region that is in a rectangular shape and displaced to one side with respect to an axis vertical to a light output surface of a light emitting element, and also has a clear outline having no blur of the light.

### SUMMARY OF THE INVENTION

A vehicle lamp according to the present invention includes at least a built-in light emitting element and polarizing lens, which is formed in a special shape, to achieve the above-described purpose.

The present invention can be grasped by a configuration described below.

(1) A vehicle lamp according to the present invention includes: a base plate; a light emitting element mounted with a light output surface faced upward on the base plate; and a polarizing lens disposed to cover the light emitting element on the base plate and formed, in a planar view, to have a larger width in a first direction orthogonal to that in a second direction, wherein the polarizing lens, in a planar view, has each side in the second direction including a first arc-shaped side and a second arc-shaped side that protrude to the outside; a diameter of the first arc-shaped side 7 is formed larger than that of the second arc-shaped side, each side in the first direction forms a curve line that is smooth and connects the first arc-shaped side and the second arc-shaped side; the cross-sectional surface along the second direction has the highest portion at its center; and a height of the convex shape is formed in such a manner to be increased from the first arc-shaped side to the second arc-shaped side and then gradually decreased.

(2) The vehicle lamp according to the present invention, in the configuration described in (1), the polarizing lens is formed with a concave surface on a surface opposing the light emitting element; and the concave surface includes an arc-shaped surface about a virtual axis extending in the second direction.

(3) The vehicle lamp according to the present invention, in the configuration described in (2), the light emitting element is, in a planar view, disposed at a center of the first direction of the arc-shaped surface of the polarized lens.

The vehicle lamp configured as described above can form the light illumination region that is in a rectangular shape and displaced to one side with respect to an axis vertical to a light output surface of a light emitting element, and also has a clear outline having no blur of the light.

### BRIEF DESCRIPTION OF THE DRAWINGS

FIGS. 1A, 1B, 1C, 1D illustrate configurations of a polarizing lens built in a vehicle lamp according to the present invention.

FIG. 2 illustrates a relationship of disposing a light emitting element and a polarizing lens that are built in a vehicle lamp according to the present invention and also an illumination region of light from the polarizing lens.

FIG. 3 is a perspective view of the polarizing lens built in the vehicle lamp according to the present invention and the illumination range of the light from the polarizing lens.

FIGS. 4A, 4B, 4C, 4D, 4E illustrate a configuration of a polarizing lens body integrally formed of the polarizing lens and a base.

FIGS. 5 illustrates a plurality of light paths leading to the light illumination region of the light emitting element through the polarizing lens corresponding to respective portions of the polarizing lens.

FIGS. 6A, 6B, 6C, 6D, 6E illustrate cross-sectional surfaces of the polarizing lens along the plurality of respective light paths illustrated in FIG. 5, and the light paths leading to the light illumination region of the light corresponding to the respective portions of the cross-sectional surfaces.

FIGS. 7A, 7B illustrate inconvenient states of the illumination ranges of the light from the light emitting element through a conventional polarizing lens.

### DESCRIPTION OF THE PREFERRED EMBODIMENTS

### [Mode for Carrying Out the Invention]

With reference to an attached drawings, an embodiment for performing the present invention (herebelow, exemplary embodiment) will be described in detail below. The same numeral will be applied to the same element throughout the descriptions of the exemplary embodiment.

### Exemplary embodiment 1

<Overall Configuration>

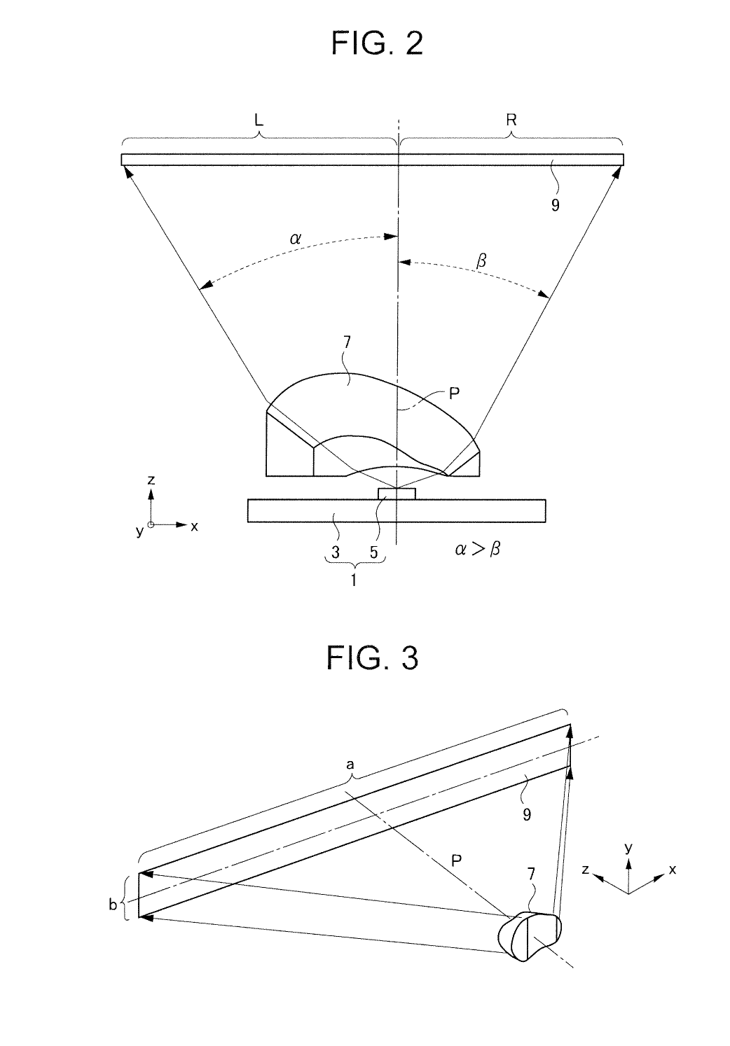

FIG. 2 illustrates a light source and the polarizing lens built in the room of the vehicle lamp according to the present invention. The vehicle lamp illustrated in FIG. 2 is used as a clearance lamp, for example. In FIG. 2, the light source 1 includes a base plate 3, and the light emitting element 5 such as the light emitting diode, for example, mounted on the base 3. The light emitting element 5 includes a light output surface on its surface (surface at an opposite side of the base plate 3), and can emit the light to radially spread about the axis “P” vertical to the light output surface.

The polarizing lens is disposed to cover the light emitting element on the base plate 3. The polarizing lens will be described in detail below. In brief, a width in an “x” direction in the diagram is formed larger than that in a “y” direction therein (direction vertical to a paper surface), and a cross-sectional surface along the “y” direction therein is formed in a convex shape having a highest portion at its center, and the height of the convex shape is formed in such a manner to be increased from one side (left side in the diagram) along the “x” direction therein to another side (right side therein) and then gradually decreased.

The light from the light emitting element 5 enters the polarizing lens 7, and output light from the polarizing lens is output to have the light illumination region on a virtual surface (e.g., screen) parallel with the board 3. The region defined by the light illumination range is referred to as a light illumination region 9 hereafter. In such a case, the output light from the polarizing lens 7 illuminates a part of the light illumination region 9 to have a spread of an angle a at a left side in the diagram with respect to the axis “P” vertical to the light output surface of the light emitting element 5, and a rest part of the light illumination region 9 to have a spread of an angle β at a right side in the diagram with respect to the axis “P”. Herein, the angles α and β are defined to have a relationship of α>β. Therefore, in the light illumination region 9, the light illumination region (indicated with a reference symbol “L” in the diagram) at the left side in the diagram with respect to the axis “P” vertical to the light output surface of the light emitting element 5 is large, and the light illumination region (indicated with a reference symbol “R” therein) at the right side in the diagram with respect to the axis “P” is small. The above-described light illumination regions mean that the light illumination region 9 is displaced (shifted) to the left side in the diagram with respect to the axis “P” vertical to the light output surface of the light emitting element. In such a case, by adjusting the angles α and β, an output direction of the light can be set. Therefore, when the light emitting element 5, the polarizing lens 7, and other optical member built in the room of the vehicle lamp having comparatively small space are disposed, the freedom of disposing them can be improved.

FIG. 3 is a perspective view of the polarizing lens 7 to clearly illustrate a shape of the light illumination region 9, and the light emitting element 5 and the base plate 3 described above are not illustrated. In FIG. 3, the light illumination region 9 has a lateral rectangular shape having a length “a” in the “x” direction in the diagram and a width “b” in the “y” direction therein, and the clear outline having no blur. The light from the polarizing lens 7 is emitted such that the luminance of the light in the light illumination region 9 is uniform for example. In such a case, when the light needs to be emitted to the other optical member such as the prism to be disposed in the room of the vehicle lamp, the light can be emitted within a predetermined region of the optical member, thereby preventing the light from getting out of the region thereof to improve effects for useful usage of the light without spoiling it.

<Configuration of Polarizing Lens>

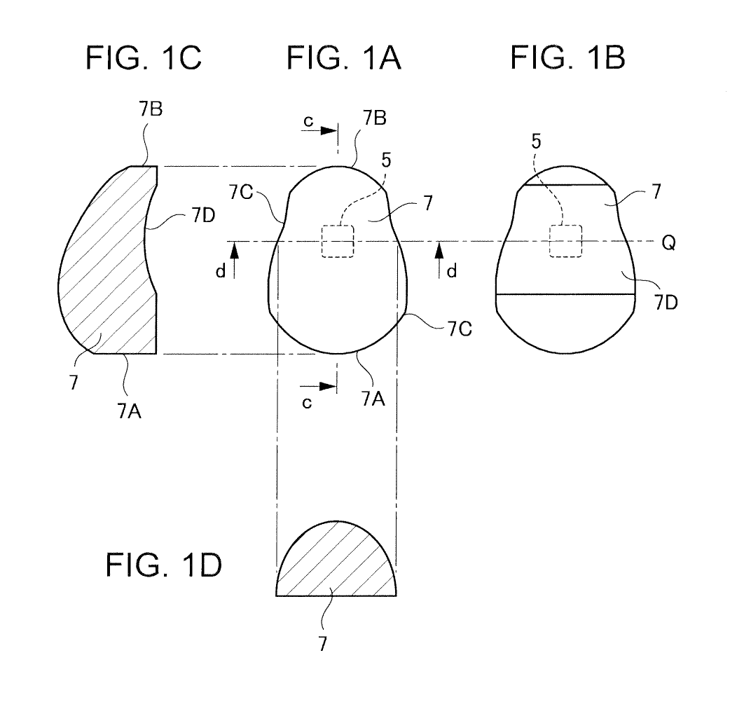

FIGS. 1A, 1B, 1C, 1D illustrate a configuration of the polarizing lens 7. FIG. 1A is a top plan view of the polarizing lens 7, FIG. 1B is a bottom plan view thereof, FIG. 1C is a cross-sectional view taken along the sectional line c-c in FIG. 1A, and FIG. 1D is a cross-sectional view taken along the sectional line d-d in FIG. 1A.

First, as illustrated in Fig. IA, the polarizing lens is formed, in a planar view, such that a width in the “x” direction (may be referred to as a first direction) in the diagram is larger than that in the “y” direction (may be referred to as a second direction) in the diagram. Each side in the “y” direction in the diagram forms each of a first arc-shaped side 7A and a second arc-shaped side 7B that protrude to the outside. In such a case, for example, a diameter (curvature) of the first arc-shaped side 7A is formed larger than that of the second arc-shaped side 7B. Each side in the “x” direction in the diagram forms a curve line side 7C that is smooth and connects the first arc-shaped side 7A to the second arc-shaped side 713.

Further, as illustrated in FIG. 1D illustrating the cross-sectional surface along the “y” direction in the diagram, the cross-sectional surface is formed in the convex shape having the highest portion at its center, and the height of the convex shape is formed in such a manner to be increased from the first arc-shaped side 7A to the second arc-shaped side 7B and then gradually decreased as illustrated in FIG. 1C illustrating the cross-sectional surface along the “x” direction.

Furthermore, as illustrated in FIG. 1B illustrating a bottom surface of the polarizing lens 7, the polarizing lens 7 is formed with a concave surface 7D (refer to FIG. 1C) on a surface opposing the light emitting element 5, and the concave surface 7D includes a surface shaped in an arc (surface of a cylinder) about a virtual axis “Q” extending in the “y” direction in the diagram. FIGS. 1A, 1B illustrate the light emitting element 5 as well as the polarizing lens 7, and the light emitting element 5 is disposed at a substantially center of the concave surface 7D of the polarizing lens 7.

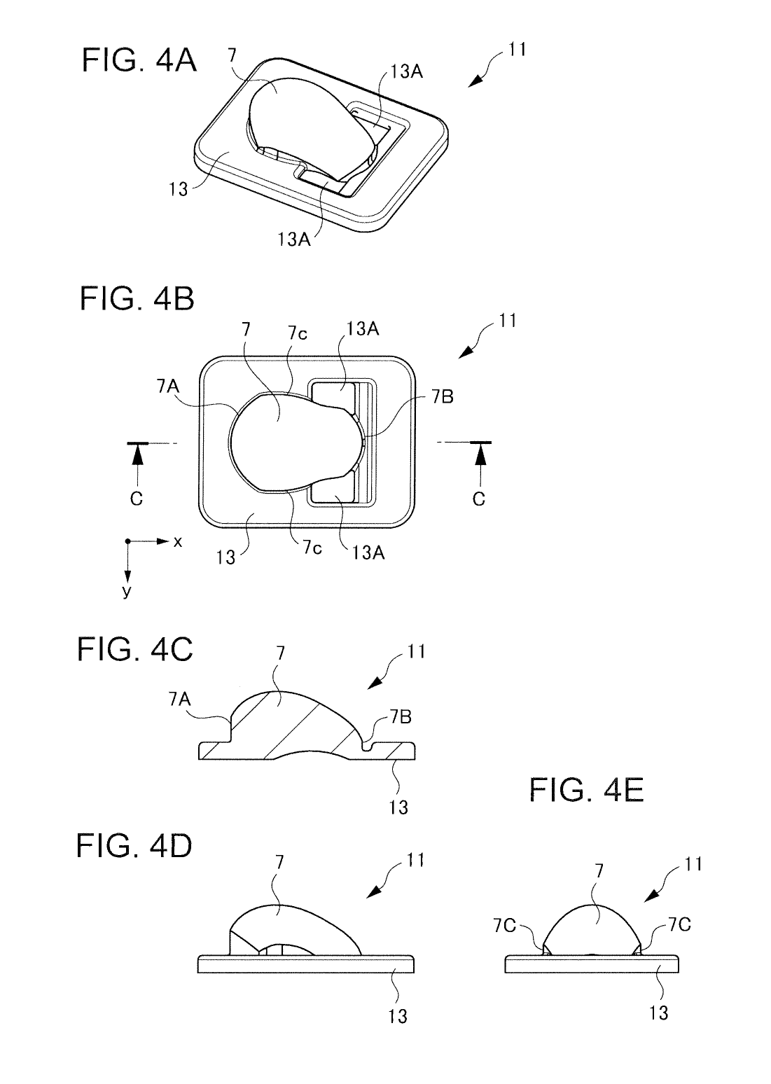

FIG. 4 illustrates a polarizing lens body 11 including the polarizing lens 7. FIG. 4A is a perspective view of the polarizing lens body 11, FIG. 4B is a top plan view thereof,

FIG. 4C is a cross-sectional view taken along the sectional line c-c in FIG. 4B, FIG. 4D is a front view thereof, and FIG. 4E is a side view thereof. In FIGS. 4A, 4B, 4C, 4D, 4E, the polarizing lens body 11 is integrally configured with the base 13 to facilitate its handling in consideration of a case where the polarizing lens 7 may be formed comparatively small. Further, with this arrangement, the polarizing lens 7 can be readily mounted onto the base plate 3 using the base 13.

The polarizing lens body 11 including the polarizing lens 7 and the base 13 as described above is formed by integrally molding with resin material for example. In FIGS. 4A, 4B, a pair of holes 13A are formed at both sides of the polarizing lens 7 on the base 13, which facilitate molding of the resin material.

<Characteristics of Polarizing Lens>

The polarizing lens configured as such has characteristics described below.

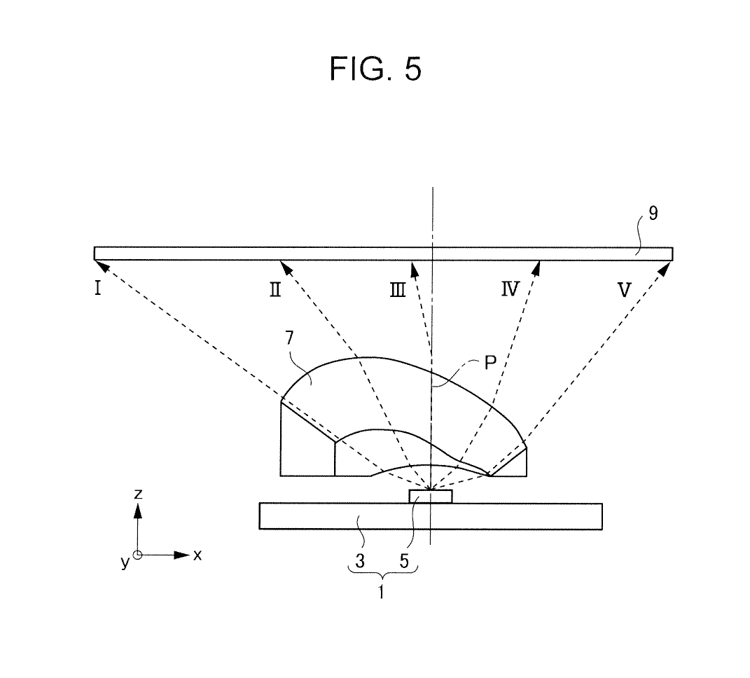

FIG. 5 illustrates light paths of the light emitting element 5 at respective portions of the polarizing lens 7 as corresponding to FIG. 2. FIG. 5 illustrates, for example, five light paths I, II, III. IV, V. Each light path of I, II, III, IV, V is disposed with a substantially equal interval from the left side in the diagram to the right side therein of the polarizing lens 7. The light on the light path III is emitted substantially corresponding to the axis vertical to the light output surface of the light emitting element 5.

In FIG. 5, the light from the light emitting element 5 enters the concave surface 7D formed on a rear surface (surface opposing the base plate 3) of the polarizing lens 7. By using the concave surface 7D, the light from the light emitting element 5 does not reflect but efficiently enters the polarizing lens 7. The light that has passed through the polarizing lens 7 is output from a front surface (surface of an opposite side of the base plate 3) of the polarizing lens 7. In such a case, the light is emitted to the light illumination region 9 such that, on the light paths I, II, III, IV, V, the light is output at an output angle corresponding to an angle (e.g., angle with the surface of the base plate) with the surface of the polarizing lens 7, the whole light including the light of the light paths I, II, III, IV, V are displaced (shifted) to the left side in the diagram with respect to the axis “P” vertical to the light output surface of the light emitting element 5.

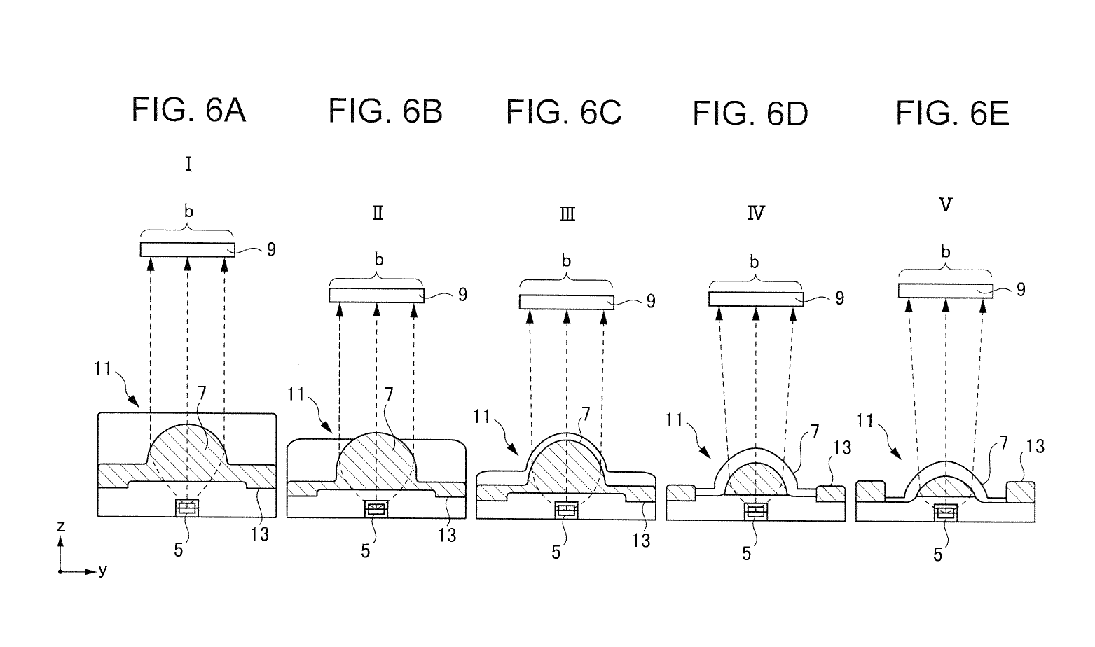

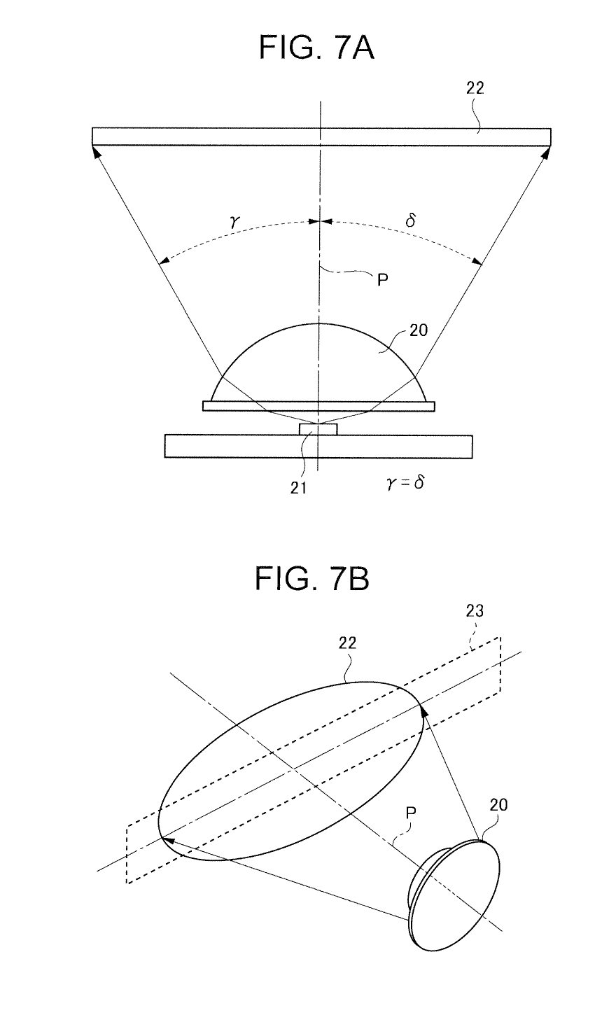

FIGS. 6A, 6B, 6C, 6E, 6E are cross-sectional views of the polarizing lens 7 at respective positions of the light paths I, II, III, IV, V illustrated in FIG. 5. More specifically, FIGS. 6A, 6B, 6C, 6D, 6E correspond to respective cross-sectional surfaces continuously illustrated from the first arc-shaped side 7A to the second arc-shaped side 7B. The polarizing lens 7 illustrated in FIGS. 6A, 6B, 6C, 6D, 6E is integrally formed with the polarizing lens body 11 illustrated in FIG. 4. The cross-sectional surfaces of the polarizing lens 7 illustrated in FIGS. 6A, 6B, 6C, 6D, 6E are formed in the convex shape, collect the light from the light emitting element 5 to output it in substantially parallel with each other (parallel in the “y” direction in the diagram). With this arrangement, the light illumination region can have the uniform width “b” along the length “a” and the clear outline having no blur. In FIGS. 6A, 6B, 6C, 6D, 6E, distances between the light illumination region 9 and the light emitting element 5 are different. This is because they are illustrated corresponding to lengths of the light paths from the light emitting element 5 to the light illumination region 9 along the light paths I, II, III, IV, V.

Regarding the above-described polarizing lens 7, each diameter (curvature) of the first arc-shaped side 7A and the second arc-shaped side 7B or the diameter (curvature) of the convex shape on the cross sectional surface on the surface orthogonal to the direction (x direction) from the first arc-shaped side 7A to the second arc-shaped side 7B can be arbitrary set according to sizes of the length “a” and the width “b” of the light illumination region 9.

The vehicle lamp configured as described above can form the light illumination region 9 displaced to the one side with respect to the axis “P” vertical to the light output surface of the light emitting element 5. Therefore, when the light emitting element 5, the polarizing lens 7, and other optical member to be built in the room of the vehicle lamp having comparatively small space are disposed therein, the freedom of disposing them can be improved. Further, the light illumination region 9 of the light emitting element 5 can be formed in a rectangular shape, and also the light illumination region 9 can have the clear outline having no blur. Therefore, when the light needs to be emitted to the other optical member such as the prism disposed in the room of the vehicle lamp, the light can be emitted within the predetermined region of the optical member and thus the light can be prevented from getting out of the region thereof, thereby improving effects for useful usage of the light without spoiling it.

The above-described vehicle lamp used as a clearance lamp is described as an example. The present invention is not limited to the clearance lamp but can be applied other vehicle lamps.

As described above, the present invention has been descried using the exemplary embodiment, however, a technical scope of the present invention is not limited to a scope described in the above-described exemplary embodiment. It is obvious for those skilled in the art to add a variety of modifications or improvements to the above-described exemplary embodiment. It is also obvious from the scope of claims that the exemplary embodiment including the variety of modifications and improvements is also included in the technical scope of the present invention.

What is claimed is:

1. A vehicle lamp comprising:
a base plate;
a light emitting element mounted with a light output surface faced upward on the base plate; and
a polarizing lens disposed to cover the light emitting element on the base plate and formed, in a planar view, to have a larger width in a first direction orthogonal to that in a second direction, wherein
the polarizing lens, in a planar view, has each side in the second direction including a first arc-shaped side and a second arc-shaped side that protrude to the outside;
a diameter of the first arc-shaped side is formed larger than that of the second arc-shaped side;
each side in the first direction forms a curve line that is smooth and connects the first arc-shaped side to the second arc-shaped side; and
the cross-sectional surface along the second direction has the highest portion at its center, and a height of the convex shape is formed in such a manner to be increased from the first arc-shaped side to the second arc-shaped side and then gradually decreased.

2. The vehicle lamp according to claim 1; wherein
the polarizing lens is formed with a concave surface on a surface opposing the light emitting element; and
the concave surface includes an arc-shaped surface about a virtual axis extending in the second direction.

3. The vehicle lamp according to claim 2; wherein
the light emitting element is, in a planar view, disposed at a center in the first direction of the arc-shaped surface of the polarized lens.
